(19) United States
(12) Patent Application Publication
(10) Pub. No.: US 2014/0238514 A1
(43) Pub. Date: Aug. 28, 2014

(54) INJECTION SYSTEM FOR DELIVERING LIQUID INTO SPRINKLER SYSTEM

(71) Applicant: Donnie Wayne Yarbrough, JR., Angleton, TX (US)

(72) Inventor: Donnie Wayne Yarbrough, JR., Angleton, TX (US)

(21) Appl. No.: 14/192,315

(22) Filed: Feb. 27, 2014

Related U.S. Application Data
(60) Provisional application No. 61/770,500, filed on Feb. 28, 2013.

(51) Int. Cl. A01C 23/04; A01M 7/00

(52) U.S. Cl. CPC A01C 23/042; A01M 7/0092
USPC 137/565.01

(57) ABSTRACT

An injection system for adding a liquid, such as a pesticide or mosquito control formula, to a sprinkler system is disclosed. The injection system includes a tank and a pump. The pump may be powered only by a low-voltage connection to the sprinkler system's timer. The pump may use a suction hose to draw piqued out of the tank. An outlet on the pump may be connected to a forked hose. One side of the fork may be a return hose for recirculating the contents of the tank. The other side of the fork may be a discharge connection hose for connecting to the sprinkler system. The discharge connection hose can further comprise an injector fitting.

### RELATED APPLICATIONS

This Application claims priority from U.S. Ser. No. 61/770,500 filed Feb. 28, 2013, the disclosure of which is incorporated herein by reference.

### BACKGROUND OF THE INVENTION

The present disclosure is directed to a device and system for delivering a liquid, such as, e.g., mosquito control solution or pesticide, into a sprinkler system, such as a lawn sprinkler system or the like. It is especially effective at delivering suspensions or emulsions that are prone to settling out after inactivity, such as oil/water systems.

Many people find mosquitoes to be annoying, but in recent years, mosquito control has become a serious public health concern, due to the advent of West Nile Virus and other factors.

One common technique for controlling a mosquito population is to treat your yard or other property with a mosquito control chemical mixture or pesticide. Many delivery systems are available. For example, if the yard has a sprinkler system, then the sprinklers could be used to spray or treat the yard. This requires a system for adding the chemicals to the sprinkler system. Several such systems are available, but all suffer from one or more drawbacks or limitations. For example, the pumps in these systems frequently fail or require priming, which may be difficult for a homeowner to perform. The treatment chemicals may separate in the tank, reducing or eliminating the effectiveness of the treatment. Additional problems also exist, such as when the pesticide or pest deterrent comprises dis-similar materials (e.g., oil/water mixtures) which separate upon standing. The instant invention provides an important solution to these problems and includes re-mixing and/or maintaining the liquid application in the system such that uniform concentration of the active ingredients is achieved.

### SUMMARY OF THE INVENTION

The present disclosure provides an injection system for adding a liquid, such as, e.g., a pesticide or mosquito control treatment, to a sprinkler system. The injection system may include a self-priming pump, a recirculating tank, or both, which results in a significant increase in the effectiveness of the treatment and other advantages apparent from the discussion herein.

Additional features, advantages, and aspects of the present disclosure may be set forth or apparent from consideration of the following detailed description, drawings, and claims. Moreover, it is to be understood that both the foregoing summary of the present disclosure and the following detailed description are exemplary and intended to provide further explanation without limiting the scope of the present disclosure as claimed.

The tank itself may be further equipped with baffles or mixing elements to enhance the mixing ability of the recirculating liquid, but is not necessarily needed depending on the miscibility of the components of the liquid. Further mixing elements, such mechanical agitators and magnetic mixers can also be included to the extent those are needed to dispense a homogeneous liquid (i.e., a liquid in which all components of the liquid are present in approximately equal amount in fractions of the liquid being dispensed).

Thus one embodiment of the invention is an injection system for injecting a liquid into a sprinkler system comprising:
a tank configured to hold a liquid;
a pump, preferably recirculating, configured to be electrically connected to a sprinkler system timer, the sprinkler system timer associated with a sprinkler system, the pump comprising an inlet and an outlet;
a suction hose configured to be inserted into the tank, the suction hose further configured to be connected to the inlet; and
a forked hose configured to be connected to the outlet, the forked hose comprising a recirculation return hose and a discharge connection hose, wherein the recirculation return hose to be inserted into the tank to transport recirculating liquid flow controlled by a recirculating flow control valve, wherein the discharge connection hose is configured to be connected to the sprinkler system.

Preferably, the discharge connection hose further comprises an injector fitting which allows discharge liquid to be injected directly into a main irrigation line of the sprinkler system. The liquid can comprise a diluted amount of a concentrate selected from the group consisting of insecticides, insect deterrents, fertilizers and herbicides, preferably wherein the liquid has an active ingredient concentration of from about 1 ounce/minute to about 36 ounces/minute.

Another aspect of the invention is an injection system for injecting a liquid into a sprinkler system comprising:
a tank configured to hold a liquid;
a pump, preferably recirculating, configured to be electrically connected to power source, the pump comprising an inlet and an outlet;
a suction hose configured to be inserted into the tank, the suction hose further configured to be connected to the inlet; and
a forked hose configured to be connected to the outlet, the forked hose comprising a recirculation return hose and a discharge connection hose, wherein the recirculation return hose is inserted into the tank to transport recirculating liquid flow, wherein the discharge connection hose further comprises an injector fitting which allows the discharge liquid to be injected directly into a main irrigation line of the sprinkler system and is configured to be connected to the sprinkler system, and wherein at least one of the recirculating flow or the discharge connection flow is controlled by a flow control valve.

Preferably both the recirculating flow and discharge connection flow are controlled by flow control valves.

The injection system can further comprise a flow switch inserted into the main irrigation line.

Preferably, the liquid comprises a diluted amount of a concentrate selected from the group consisting of insecticides, insect deterrents, fertilizers and herbicides, preferably wherein the liquid has an active ingredient concentration of from about 1 ounce/minute to about 36 ounces/minute.

A third embodiment of the invention is a system for continuously mixing suspending a liquid medium for use in injecting into an application system, comprising
a tank configured to hold a liquid medium;
a pump, preferably recirculating, configured to be electrically connected to a power source, the pump comprising an inlet and an outlet;
a suction hose configured to be inserted into the tank, the suction hose further configured to be connected to the inlet;
a forked hose configured to be connected to the outlet, the forked hose comprising a recirculation return hose for recirculating liquid flow and a discharge connection hose for discharge liquid flow, wherein the recirculation return hose is inserted into the tank to transport recirculating liquid, the discharge connection hose further comprising an injector fitting which allows discharge liquid to be injected directly into a main line of the application system, and wherein at least one of the recirculating liquid flow or the discharge liquid flow is controlled by a flow control valve. Either of the recirculating liquid flow and discharge liquid flow can be controlled by flow control valves. Preferably, however, both the recirculating liquid flow and discharge liquid flow are controlled by flow control valves.

The liquid medium preferably comprises an incompatible mixture comprising an aqueous based liquid and at least one oil based liquid. However, the liquid medium can comprise an emulsion or a suspension.

Preferably the liquid medium comprises a diluted amount of a concentrate selected from the group consisting of insecticides, insect deterrents, fertilizers and herbicides. The liquid preferably has an active ingredient concentration of from about 1 ounce/minute to about 36 ounces/minute.

### BRIEF DESCRIPTION OF THE DRAWINGS

FIG. 1 shows a liquid injection system comprising a single recirculating valve, according to an aspect of the present invention.

FIG. 2 shows the liquid injection system of FIG. 1 with a cover removed.

FIG. 3 shows a cutaway view of the liquid injection system of FIG. 1.

FIG. 4 shows a plan view of a portion of the liquid injection system of FIG. 1.

FIG. 5 shows an electrical schematic of a liquid injection system, according to an aspect of the present invention.

FIG. 6 shows a liquid injection system comprising dual recirculating valves, according to an aspect of the present invention.

FIG. 7 shows the liquid injection system of FIG. 6 with a cover removed.

FIG. 8 shows a cutaway view of the liquid injection system of FIG. 6.

FIG. 9 shows a plan view of a portion of the liquid injection system of FIG. 6.

FIG. 10 shows an electrical schematic of a liquid injection system, according to an aspect of the present invention.

### DETAILED DESCRIPTION OF THE INVENTION

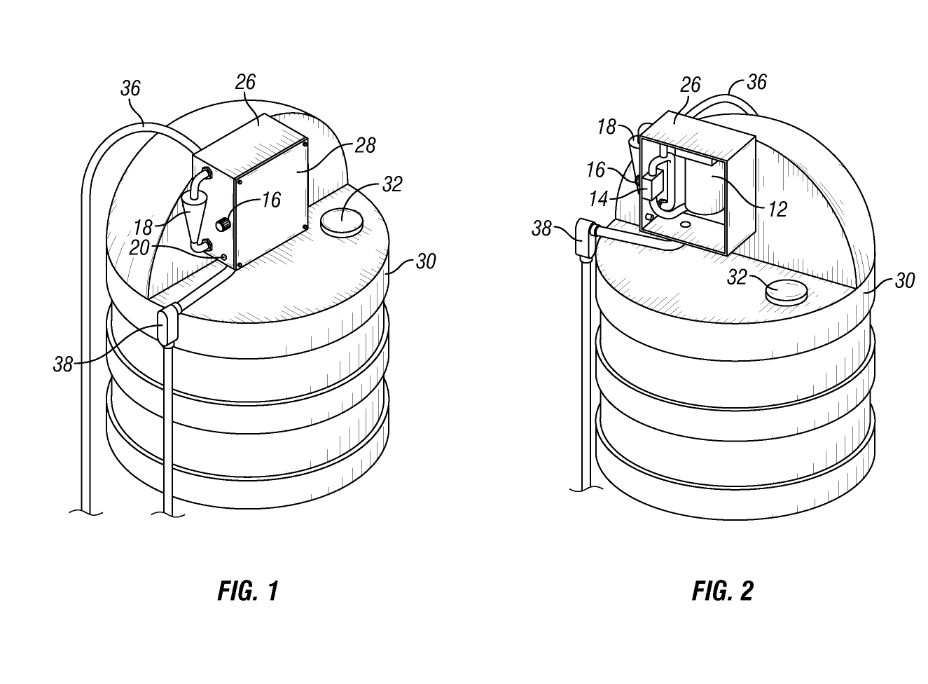

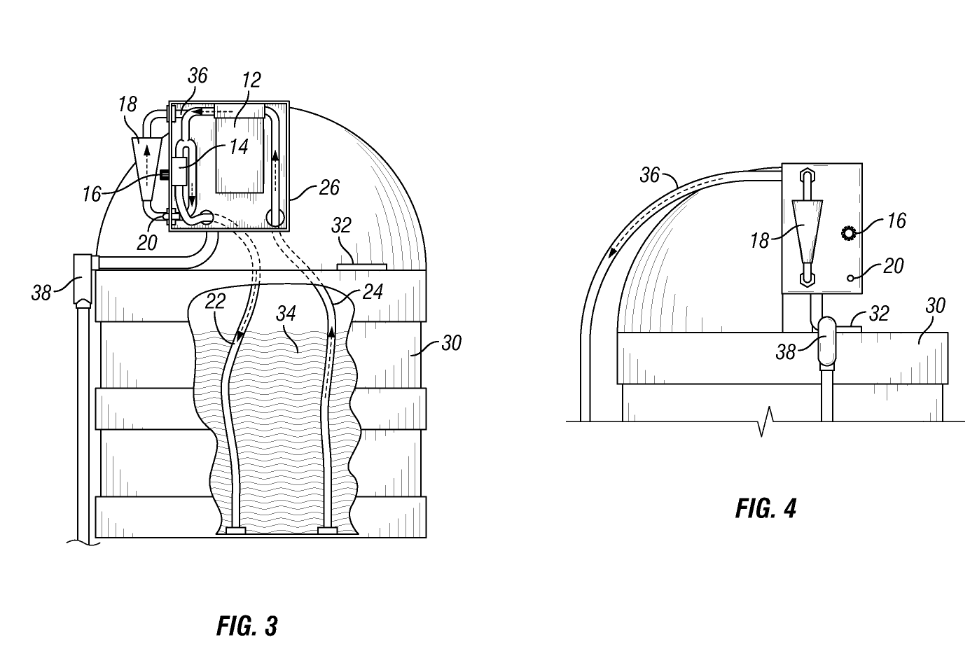

FIG. 1 shows a liquid injection system, according to the aspects of the present invention. The liquid injection system may include a tank 30 with a cap 32 structured and arranged to store a liquid 34 (FIG. 3), such as, e.g., a mosquito control liquid, for injection into a sprinkler system. A valve box enclosure 26, with a cover 28, may be associated with the tank 30. A discharge connection hose 36 may connect the injection system to the sprinkler system, and an electrical conduit 38 may provide the injection system with power. The electrical conduit 38 comprises an electrical junction box or conduit for protection of wiring from junction box to soil. The discharge connection hose 36 allows the liquid to be injected directly into the main irrigation line (not shown) of the sprinkler system downstream from the back flow prevention valve (not shown) in that main irrigation line.

The enclosure 26 may include a recirculating flow control valve knob 16, a flow control sight gauge 18, and an indicator light 20. The flow control knob 16, flow control sight gauge 18, and indicator light 20 may be located on the external surface of the enclosure 26. The indicator light 20, which may include e.g., a light-emitting diode (LED), incandescent bulb, or any other suitable light source, may be illuminated when the injection system is active or otherwise receiving power. The sight gauge 18 may provide a visual indicator that liquid 34 (shown in FIG. 3) is flowing through the injection system and into the sprinkler system. For example, the sight gauge 18 may include a small ball inside the inverted cone.

As liquid 34 flows through the gauge 18, the ball may rise inside the gauge 18. The higher the ball rises, the higher the flow of liquid 34 through line 36 may be. The recirculating flow control valve knob 16 may allow a user, operator, or owner, to adjust and balance the flow of liquid 34, and these changes may be visualized in the gauge 18. By balancing the recirculating flow through line 22 (shown in FIG. 3) and the discharge flow through line 36, adequate dosing of the liquid is achieved and controlled.

FIG. 2 shows the liquid injection system of FIG. 1 with a cover 28 removed. An adjustable flow control valve 14 may be located inside the enclosure 26, and this valve 14, may be adjusted by turning or twisting the flow control knob 16. A self-priming pump 12 may also be located inside the enclosure 26. The self-priming pump 12 may allow a user or owner to operate the system without priming the pump after refilling the tank 30. When the system runs out of liquid 34, the user may be able to simply add more liquid 34 and walk away, without the system requiring any further action to return to operational status. The pump 12 may be configured to weather conditions. The pump 12 may be able to run dry (e.g. without any liquid in the tank 30) without damage.

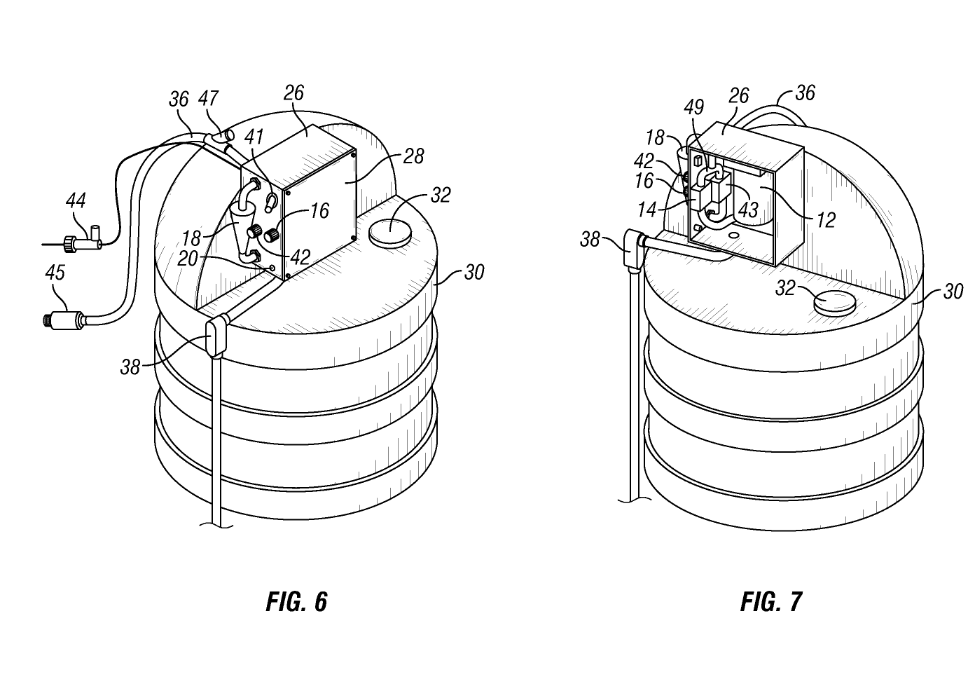

FIG. 3 shows a cutaway view of the liquid injection system FIG. 1, and FIG. 4 shows a plan view of a portion of the liquid injection system of FIG. 1. The pump 12 may draw the liquid 34 out of the tank 30 via the suction hose 24. The discharge line from the pump 12 may fork or divide. One side of the fork may be a recirculation return hose 22, while the other side may be a discharge connection hose 36 (which runs through the sight gauge 18). The discharge side of the fork may connect through the adjustable recirculating flow control valve 14 to the connection hose 36 to the sprinkler system, or it may flow through a discharge flow control valve (if used). Thus, at least one flow control valve is used in the invention. If one flow control valve is used, it controls the recirculating flow of the liquid back to the tank, with the remainder of the flow going into the discharge connection line 36. However, it is preferred to use two valves as shown in FIGS. 6, 7, 8 and 9)—one valve 14 for control of recirculating flow and one valve 43 for discharge flow control to the sprinkler system.

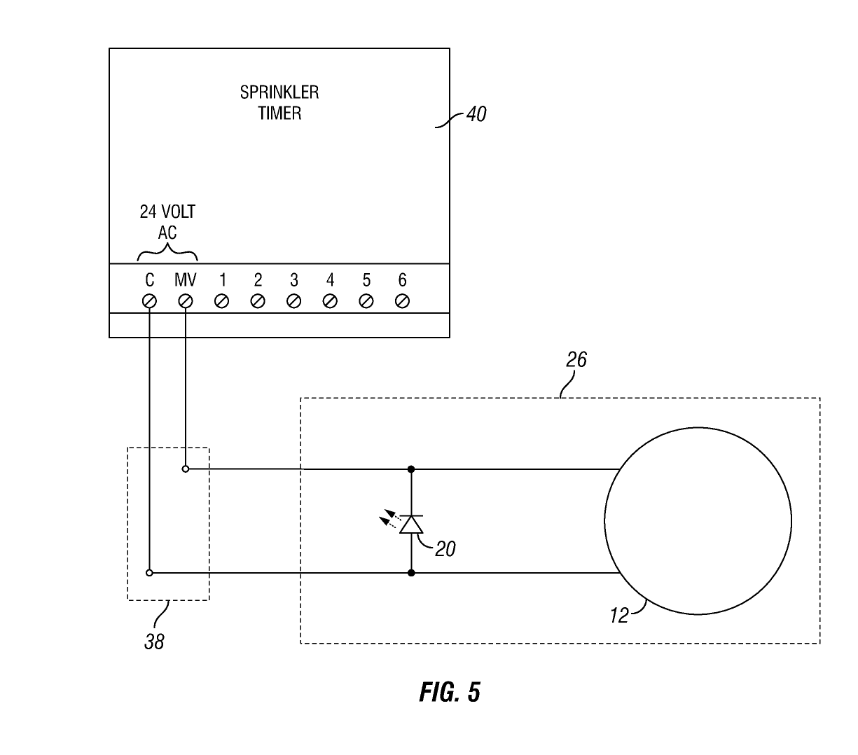

FIG. 5 shows an electrical schematic of a liquid injection system, according to an aspect of the present invention. The pump 12 may be electrically connected to a lawn sprinkler timer 40. For example, the pump 12 may have a low-voltage connection to pump MV (master valve) on the timer 40. The pump 12 may not require any power source other than the connection to the timer 40. The user may set or program the sprinkler timer 40 to activate the pump 12 when one or more zones of the sprinkler system are activated.

FIG. 6 shows a liquid injection system, according to the aspects of the present invention. The liquid injection system may include a tank 30 with a cap 32 structured and arranged to store a liquid 34, such as, e.g., a mosquito control liquid, for injection into a sprinkler system. A valve box enclosure 26, with a cover 28, may be associated with the tank 30. A discharge connection hose 36 may connect the injection system to the sprinkler system, and an electrical conduit 38 may provide the injection system with power. The discharge connection hose 36 comprises an injector fitting 45 which allows the liquid to be injected directly into the main irrigation line (not shown) of the sprinkler system downstream from the back flow prevention valve (not shown) in that main irrigation line. Flow control switch 44 is active by liquid flow through the main sprinkler line (not shown) such that when water is pumping through the sprinkler system, the pump is active by the flow control switch 44.

The enclosure 26 may include a recirculating flow control valve knob 16 and discharge flow control valve knob 42 (FIG. 6), a flow control sight gauge 18, an on/off toggle switch 41, and an indicator light 20. The flow control knobs 16 and 42, flow control sight gauge 18, toggle switch 41, and indicator light 20 may be located on the external surface of the enclosure 26. The indicator light 20, which may include e.g., a light-emitting diode (LED), incandescent bulb, or any other suitable light source, may be illuminated when the injection system is active or otherwise receiving power. The sight gauge 18 may provide a visual indicator that liquid 34 (shown in FIG. 3) is flowing through the injection system and into the sprinkler system. For example, the sight gauge 18 may include a small ball inside the inverted cone.

As liquid 34 flows through the gauge 18, the ball may rise inside the gauge 18. The higher the ball rises, the higher the flow of liquid 34 through line 36 may be. The recirculating flow control valve knob 16 and discharge flow control valve knob 42 may allow a user, operator, or owner, to adjust and balance the flow of liquid 34, and these changes may be visualized in the gauge 18. By balancing the recirculating flow through line 22 and the discharge flow through line 36, adequate dosing of the liquid is achieved and controlled.

FIG. 7 shows the liquid injection system of FIG. 6 with a cover 28 removed. An adjustable flow control valve 14 may be located inside the enclosure 26, and this valve 14, may be adjusted by turning or twisting the flow control knob 16. A self-priming pump 12 may also be located inside the enclosure 26. The self-priming pump 12 may allow a user or owner to operate the system without priming the pump after refilling the tank 30. When the system runs out of liquid 34, the user may be able to simply add more liquid 34 and walk away, without the system requiring any further action to return to operational status. The pump 12 may be configured to weather conditions. The pump 12 may be able to run dry (e.g. without any liquid in the tank 30) without damage.

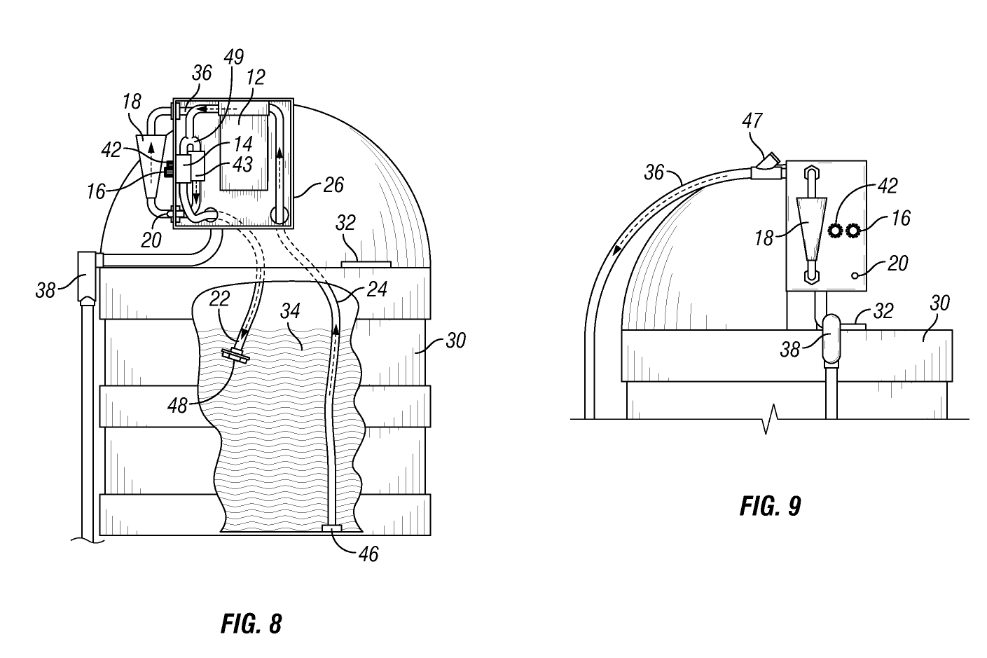

FIG. 8 shows a cutaway view of the liquid injection system FIG. 6, and FIG. 9 shows a plan view of a portion of the liquid injection system of FIG. 6. The pump 12 may draw the liquid 34 out of the tank 30 via the suction hose 24. The discharge line from the pump 12 may fork or divide 49. One side of the fork 49 may be a recirculation return hose 22, while the other side may be a discharge connection hose 36 (which runs through the sight gauge 18). The discharge side of the fork 49 may connect through the adjustable recirculating flow control valve 14 to the connection hose 36 to the sprinkler system, or it may flow through discharge flow control valve 43. Thus, at least one flow control valve is used in the invention. If one flow control valve is used, it controls the recirculating flow of the liquid back to the tank, with the remainder of the flow going into the discharge connection line 36. However, it is preferred to use two valves as shown in FIGS. 6, 7, 8 and 9)—one valve 14 for control of recirculating flow and one valve 43 for discharge flow control to the sprinkler system.

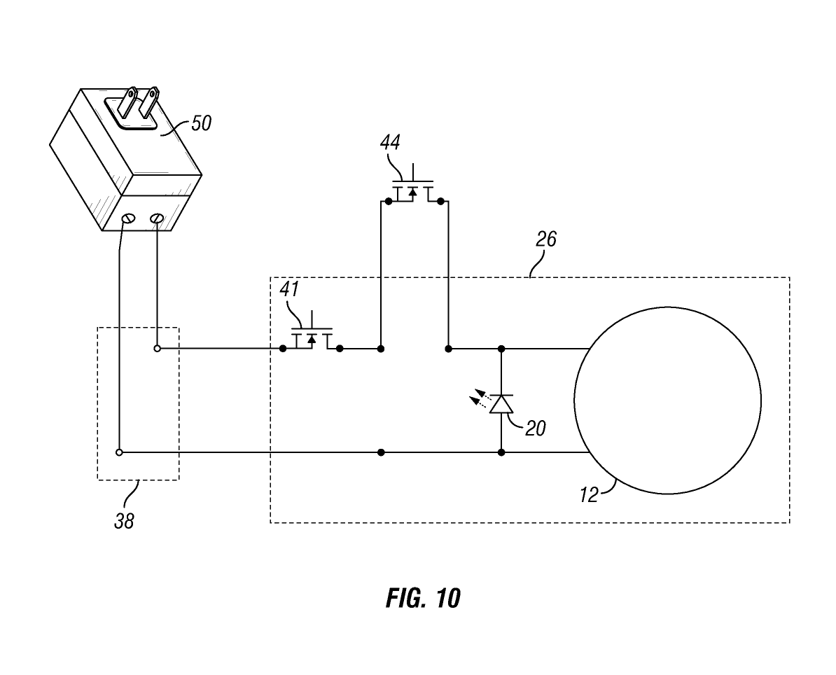

FIG. 10 shows an electrical schematic of a liquid injection system, according to an aspect of the present invention. The pump 12 may be electrically connected to a power source 50. An on/off toggle switch 41 may be employed to manually turn on/off the power to the pump 12 (FIG. 10). FIG. 10 also shows the flow switch 44 connection to activate the pump 12.

Table of identifying numbers for FIGS. 1-10:

| Element | |
|---|---|
| Number | Description |
| 12 | Pump |
| 14 | Recirculating flow control valve |
| 16 | Recirculating flow control valve knob |
| 18 | Sight gauge |
| 20 | Indicator light |
| 22 | Recirculation return hose |
| 24 | Suction hose |
| 26 | Valve box enclosure |
| 28 | Valve box enclosure cover |
| 30 | Tank |
| 32 | Tank cap |
| 34 | Liquid |
| 36 | Discharge connection hose |
| 38 | Electrical conduit |
| 40 | Sprinkler timer |
| 41 | On/off toggle switch |
| 42 | Discharge flow control valve knob |
| 43 | Discharge flow control valve |
| 44 | Flow switch |
| 45 | Injector fitting |
| 46 | Footer valve |
| 47 | Check valve |
| 48 | Return cap fitting having 3 holes |
| 49 | Forked (or “Y”) hose |
| 50 | Power supply |

The liquid which can be used in the system can be at least one insecticide or insect deterrent, such as CedarCide™ organic pest control (Pest Control Operators (PCO) Choice product). The liquid can also be at least one fungicide (or weed killer). The liquid can also be at least one fertilizer targeting growth enhancement of various plants, including grass, shrubs, trees, flowers, vegetable gardens and the like. The liquid can also be mixtures of these additives. For example, the liquid can comprise an insecticide or insect deterrent in combination with at least one lawn fertilizer. Various concentrations of any of these can be used, but general, for insect deterrent and treatment, the concentration is from 1 quart to about 4 gallons. Application or dosing of the liquid active ingredient is typically from 0.1 ounces/minute to about 36 ounces/minute, but is preferably from about 0.1 ounces/minute to about 20 ounces/minute for pest control products in general, e.g., mosquito control or deterrents.

The design of the inventive direct injection system includes micro dosing a mixture of liquid product (pest control product, liquid fertilizer, fire retardant, liquid mold protection, detergents, rodent repellent, wildlife deterrent product, rust stain removal and prevention products, scale or calcium reduction, removal and prevention products, etc.) into a main flowing line of any system, which may include a lawn sprinkler system, a fire sprinkler system, an aerobic septic system, farming irrigation system, car wash system, pressure cleaning systems, etc. The system could be used as a delivery system of soaps, conditioners, insect repellent, etc. connecting into a water source used for the purpose of washing down pets, livestock, etc. Selection of liquid to apply will require proper selection of pump seals and diaphragm, etc. For example, when using acidic liquids, one should use flouroelastomer materials such as VITON™.

The design of the inventive injection system can be used for the application of product into many different tubing systems or to open air delivery, as well. This design can be used as a micro dosing application system. It can act as the delivery system of any mixture of products and become the sole source of product in need of applying. Examples may be delivery of liquid deer attractant to an area that people would hunt, pest repellent that is to be applied in small doses directly to an area, etc. Other examples are application of colored dyes, algae control into a water feature, pond, lake, swimming pool, etc.

For liquid product manufacturing or mixing, this inventive injection system could be used as a mixing tank for such products and then be used for the filling of product bottles.

The design of the inventive injection system using minimum of one, or more, flow regulating valves, will allow for precise adjustment thus allowing for very precise liquid dosing and mixture recirculation.

Unlike many—if not all—other direct application systems, this system has a regulated flow return for proper recirculation. The need for such is very important when mixing or combining multi weighted products, oils, detergents, repellents, attractants, etc. Without such feature, the probability of mixture separation is very high, thus causing inaccurate product mixture being applied as the product levels drop in the tank. For example, without proper recirculation, oils will tend to rise above water based product, etc. whenever the system has not functioned for a while, once system is activated, the system automatically starts the remixing of the multi weighted product.

The inventive injection system is designed to have adjusting flow regulating valves which allows for the adjustment of product dosing when more product may be needed for the allotted amount of time. For example, the standard residential lawn sprinkler system may only need a minimal amount of product, but in a larger system with higher mainline flow, more product dosage per minute may be needed to maintain accurate ratios.

The benefits of this low voltage pumping system include a low amount of electrical usage while system is non-active. Once the system is activated, the amount of low voltage electricity is minimal.

In circumstances when the flow switch is used, one would think that the system will have to be used mandatorily every time the mainline that activates the switch, but this system has a manual toggle switch 41 to bypass this system until the system is needed in the future. When the system is activated, the system is equipped with an LED light 20 showing that the system has been activated by flowing water.

In all aforementioned applications, the system is connected to a class 2 transformer 50.

The single pump system has two functions in the process of flowing product. One being the outpouring flow of product either injected into a main flowing line or in situations of direct application and the second is for the recirculation of product return for the purpose of mixing. As more product is injected or applied, less product is being returned for remixing. Both valves are to be adjusted to regulate flow mixtures.

A screened footer valve 46 is used to guarantee that coagulated product doesn't get into the pumping system. The footer valve will keep flow of product positive thus keeping the pump primed between times of operation.

The check valve 47 protects from the reverse of product flow from main pressure line into the pumping system.

In applications where the injection fitting is needed, this fitting works as the first of two protective check valves controlling mainline pressures, guaranteeing that reverse flow does not occur.

The direct injection system may be either retro fitted to an existing sprinkler system or can be fitted at the time the irrigation system is installed.

The inventive injection system of the second embodiment or aspect does not rely on the power of the sprinkler system timer.

The third aspect of the invention does not have to be tied to a lawn sprinkler system at all, and is a means for maintaining the concentration of immiscible liquids, such as oil/water emulsions or suspensions while simultaneously injecting, applying or spraying those liquids. The third aspect/embodiments of the invention can also be attached to a commercial or residential fire sprinkler system to apply fire deterring chemicals while and when the overall system is activated. This third embodiment can also be used in direct application of other liquids and chemicals, particularly where there is a need for keeping otherwise incompatible liquids at relatively constant concentration throughout application (i.e., without settling of the contents during application of the liquids).

1. An injection system for injecting a liquid into a sprinkler system comprising:
a tank configured to hold a liquid;
a pump configured to be electrically connected to a sprinkler system timer, the sprinkler system timer associated with a sprinkler system, the pump comprising an inlet and an outlet;
a suction hose configured to be inserted into the tank, the suction hose further configured to be connected to the inlet; and
a forked hose configured to be connected to the outlet, the forked hose comprising a recirculation return hose and a discharge connection hose, wherein the recirculation return hose to be inserted into the tank to transport recirculating liquid flow controlled by a recirculating flow control valve, wherein the discharge connection hose is configured to be connected to the sprinkler system.

2. The injection system of claim 1, wherein the discharge connection hose further comprises an injector fitting which allows discharge liquid to be injected directly into a main irrigation line of the sprinkler system.

3. The injection system of claim 1, wherein the liquid is a diluted amount of a concentrate selected from the group consisting of insecticides, insect deterrents, fertilizers and herbicides.

4. The injection system of claim 1, wherein the pump is a recirculating pump.

5. The injection system of claim 1, wherein the liquid has an active ingredient concentration of from about 1 ounce/minute to about 36 ounces/minute.

6. An injection system for injecting a liquid into a sprinkler system comprising:
a tank configured to hold a liquid;
a pump configured to be electrically connected to power source, the pump comprising an inlet and an outlet;
a suction hose configured to be inserted into the tank, the suction hose further configured to be connected to the inlet; and
a forked hose configured to be connected to the outlet, the forked hose comprising a recirculation return hose and a discharge connection hose, wherein the recirculation return hose is inserted into the tank to transport recirculating liquid flow, wherein the discharge connection hose further comprises an injector fitting which allows the discharge liquid to be injected directly into a main irrigation line of the sprinkler system and is configured to be connected to the sprinkler system, and wherein at least one of the recirculating flow or the discharge connection flow is controlled by a flow control valve.

7. The injection system of claim 6, wherein both the recirculating flow and discharge connection flow are controlled by flow control valves.

8. The injection system of claim 6, further comprising a flow switch inserted into the main irrigation line.

9. The injection system of claim 6, wherein the liquid is a diluted amount of a concentrate selected from the group consisting of insecticides, insect deterrents, fertilizers and herbicides.

10. The injection system of claim 6, wherein the pump is a recirculating pump.

11. The injection system of claim 6, wherein the liquid has an active ingredient concentration of from about 1 ounce/minute to about 36 ounces/minute.

12. A system for continuously mixing and suspending a liquid medium for use in injecting into an application system, comprising
a tank configured to hold a liquid medium;
a pump configured to be electrically connected to a power source, the pump comprising an inlet and an outlet;
a suction hose configured to be inserted into the tank, the suction hose further configured to be connected to the inlet;
a forked hose configured to be connected to the outlet, the forked hose comprising a recirculation return hose for recirculating liquid flow and a discharge connection hose for discharge liquid flow, wherein the recirculation return hose is inserted into the tank to transport recirculating liquid flow, the discharge connection hose further comprising an injector fitting which allows discharge liquid to be injected directly into a main line of the application system, and wherein at least one of the recirculating liquid flow or the discharge liquid flow is controlled by a flow control valve.

13. The injection system of claim 12, wherein both the recirculating liquid flow and discharge liquid flow are controlled by flow control valves.

14. The injection system of claim 12, wherein the liquid medium comprises an incompatible mixture comprising an aqueous based liquid and at least one oil based liquid.

15. The injection system of claim 12, wherein the liquid medium comprises an emulsion.

16. The injection system of claim 12, wherein the liquid medium comprises a suspension.

17. The injection system of claim 14, wherein the liquid medium is a diluted amount of a concentrate selected from the group consisting of insecticides, insect deterrents, fertilizers and herbicides.

18. The improved injection system of claim 12, wherein the pump is a recirculating pump.

19. The improved injection system of claim 12, wherein the liquid has an active ingredient concentration of from about 1 ounce/minute to about 36 ounces/minute.
